(19) United States
(12) Patent Application Publication
(10) Pub. No.: US 2010/0070894 A1
(43) Pub. Date: Mar. 18, 2010

(54) FEDERATED CALENDAR ENTRY PRESENCE INDICATOR

(75) Inventors: Ram Krishnamurthy, Westford, MA (US); John M. Lance, Littleton, MA (US); Frank A. Pavelski, Bolton, MA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/211,401

(22) Filed: Sep. 16, 2008

(51) Int. Cl. G06F 3/048

(52) U.S. Cl. 715/764

(57) ABSTRACT

A method for indicating the presence of federated calendar entries in a currently viewed time period of a calendar and/or scheduling application, includes: receiving a user's selection for a date range in a calendar and/or scheduling application; determining whether there are one or more federated calendars associated with the user's calendar and/or scheduling application; wherein in the event there are one or more federated calendars associated with the user's calendar and/or scheduling application: determining whether there are one or more events from the one or more federated calendars in the selected date range; and wherein in the event there are federated calendar events in the selected date range: generating a calendar and/or scheduling page with one or more indicators for federated calendars with events in the selected date range.

### BACKGROUND

This invention relates generally to electronic scheduling software, and more particularly to providing a method and system for an electronic calendar and scheduling application with graphical user interface indictors for the presence of federated calendar entries in a currently viewed time period.

Electronic scheduling programs have become a central feature of modem life and have become quite prevalent in and out of the work environment. For example, during the course of one day of travel, a user may utilize an electronic scheduling application at a home desktop computer in the early morning, an office desktop computer in midmorning, via a cell phone or personal digital assistant in a taxi on the way to the airport, on a laptop computer via a wireless local area network while waiting in the airport lounge, via an in-flight telephone on the airplane, and in a hotel room via a high-speed Internet connection provided by the hotel at the end of the day. The widespread use of electronic scheduling applications has increased the demands for improved features, ease of use, and enhanced productivity solutions.

### SUMMARY

Embodiments of the present invention provide a method for indicating the presence of federated calendar entries in a currently viewed time period of a calendar and/or scheduling application, the method includes: receiving a user's selection for a date range in a calendar and/or scheduling application; determining whether there are one or more federated calendars associated with the user's calendar and/or scheduling application; wherein in the event there are one or more federated calendars associated with the user's calendar and/or scheduling application: determining whether there are one or more events from the one or more federated calendars in the selected date range; and wherein in the event there are federated calendar events in the selected date range: generating a calendar and/or scheduling page with one or more indicators for federated calendars with events in the selected date range.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates graphical user interface indictors for the presence of federated calendar entries in a currently viewed time period of a calendar and/or scheduling application according to embodiments of the invention.

FIG. 2 illustrates a flow chart for a method for an electronic calendar and/or scheduling application to indicate the presence of federated calendar entries in a currently viewed time period of the calendar and/or scheduling application according to embodiments of the invention.

FIG. 3 illustrates a system for implementing embodiments of the invention.

The detailed description explains the preferred embodiments of the invention, together with advantages and features, by way of example with reference to the drawings.

### DETAILED DESCRIPTION

Electronic calendar and/or scheduling programs and software products are configured for the effective time management of users. Many electronic calendars are configured to obtain, integrate, and share information from other calendars that belong to groups and organizations subscribed to by the user. The shared (also referred to as federated) calendar feature provides users with the ability to track events of interest on their personal calendars. For example, a baseball fan may integrate their favorite team's schedule, as provided by a calendar generated by the team, into their personal calendar. However, existing calendar and/or scheduling interfaces fail to provide a user with an indication if a federated or shared calendar actually has an entry in the time period currently being viewed, or whether the calendar has an entry in the time period that is being viewed, but the entry is simply not currently visible (i.e., the entry is scrolled off the screen).

Embodiments of the invention provide a method and system for an electronic calendar and/or scheduling application with graphical user interface indictors for the presence of federated calendar entries in a currently viewed time period. For example, if a user subscribes to a football team calendar, but is currently viewing the month of April, it is unlikely that they will actually see any events for that calendar because football is generally not played in April. In this instance, embodiments of the invention would indicate that the calendar does not have any entries for the currently viewed period for the shared or federated football calendar. Conversely, if the user were to move to October, when football is generally played, embodiments of the invention would indicate that there are events for the football calendar. In addition, embodiments of the invention may also indicate that there are no entries present in an added federated calendar at all, that is, a user has added an empty calendar.

In a second exemplary embodiment of the invention, a user may subscribe to a book club's calendar. In this example, the book club meetings typically take place at 7:00 pm, which is below the time slots that the user is currently viewing (for example 9:00 AM to 5:00 PM). In this instance, embodiments of the invention would indicate to the user that there is a meeting; however, the meeting is simply not currently being viewed. Such an embodiment may also apply to calendar entries that do not appear in the date range being viewed. For example, for a book club meeting that is once a month, during the third week of the month, and the user is viewing the Monday-Friday range of the first week of the month, embodiments of the invention would indicate that there is a meeting but it is not in the date range currently being viewed.

Embodiments of the invention provide a summary view to the user of which calendar entries are hidden without having to scroll the hidden calendar entries into the view.

Embodiments of the invention are configured with a series of graphical user interface (GUI) indicators that display whether a federated (shared) calendar has an event(s) in the time range of a user's primary scheduling calendar, when the event(s) is currently visible on a user's screen display, or an indication that the user's primary scheduling calendar does have an event in the time range, but it is not currently visible (e.g., scrolled off the page). Conversely, the GUI of embodiments of the invention also indicates that the primary scheduling calendar does not have any events in the currently displayed range from a shared calendar. With embodiments of the invention, a user may obtain a summary of the shared calendar events in the time range. For example, a summary may be obtained by hovering the user's mouse or other pointing and stylus devices over the indicator. The summary may include links that the user clicks on to quickly bring the entry into view. In embodiments of the invention, an additional summary may be available from a calendar's day header, whereby the user may get obtain a snapshot of the different entries for that day, and the originating calendars, which is particularly useful in a month or year calendar layout.

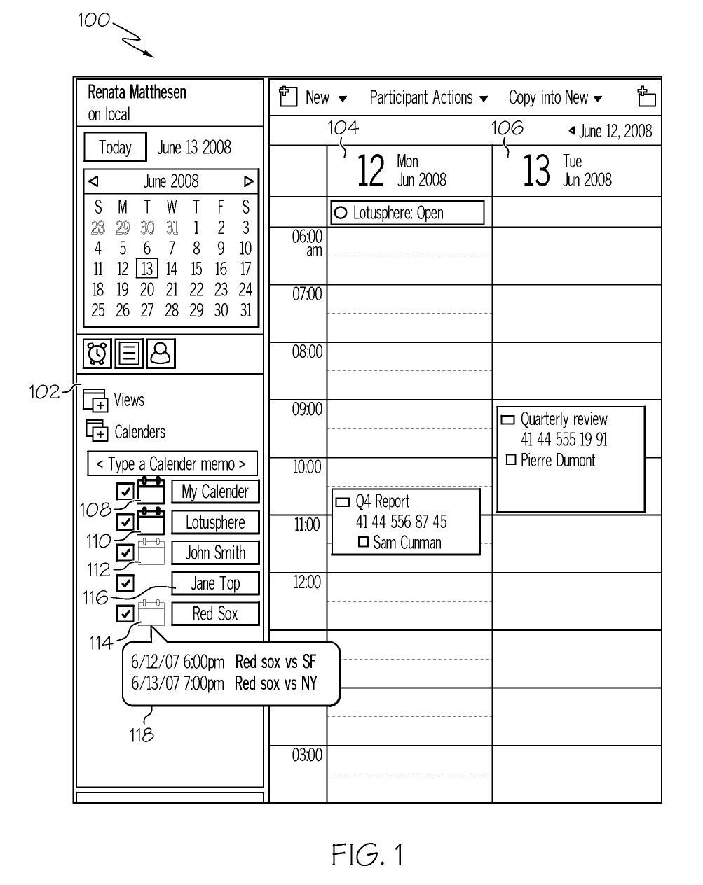

FIG. 1 illustrates an example of a calendar and/or scheduling application 100 with a graphical user interface section 102 for indicating the presence of federated calendar entries in a currently viewed time period of the calendar and/or scheduling application 100 according to embodiments of the invention. In the present example, columns 104 and 106 display schedule entries for June 12 and June 13, respectively. The calendar icons (or other symbols and indicators) 108, 110, 112, and 114 indicate that the calendar has events in the date range currently selected. The calendar icons in bold (or highlighted) (108, 110) indicate that the event entry is presently visible on the user's display, whereas calendar icons that are not in bold (i.e., faint or transparent) (112, 114) indicate events are in the selected date range, but are currently not visible and require the user to scroll or advance the calendar view down. The absence of a calendar icon next to the calendar event entry for Jane Top 116 indicates to the user that there are no entries for Jane Top in the selected date range. Hovering over the calendar icon 114 results in a pop up 118 with additional information for the calendar entry. In the present example, further information about the Red Sox game schedule is shown in the pop up 118.

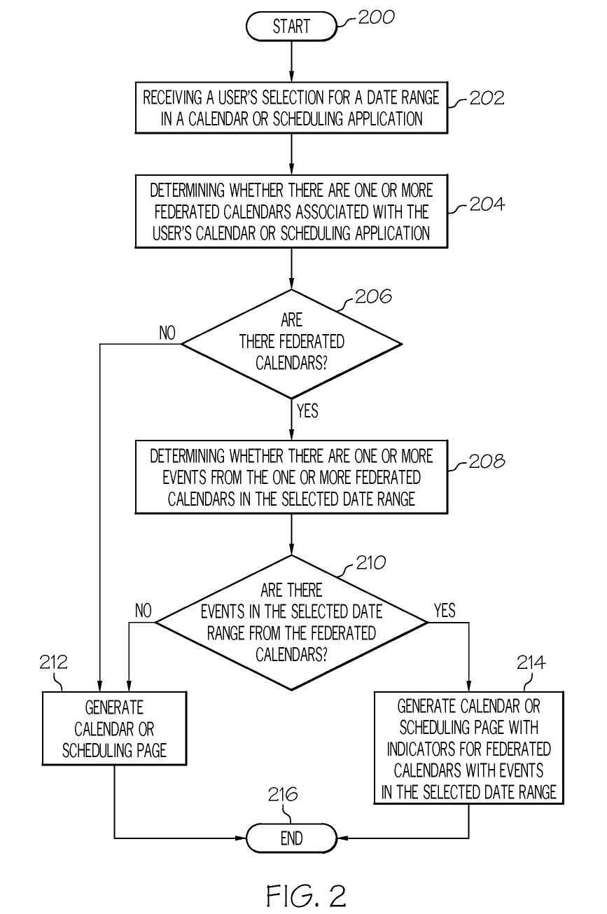

FIG. 2 illustrates a flow chart for a method for an electronic calendar and/or scheduling application to indicate the presence of federated calendar entries in a currently viewed time period of the calendar and scheduling application according to embodiments of the invention. The process starts (block 200) with the receiving of a user's selection for a date range in a calendar and/or scheduling application (block 202). Subsequently, a determination is made on whether there are one or more federated calendars associated with the user's calendar and/or scheduling application (block 204). In the event there are no federated calendars associated with the user's calendar and/or scheduling application (decision block 206 is No), a calendar and/or scheduling page is generated (block 212), and the process concludes (block 216). However, in the event there are federated calendars associated with the user's calendar and/or scheduling application (decision block 206 is Yes), a determination is made whether there are one or more events from the one or more federated calendars in the selected date range (block 208). In the event there are no federated calendar events in the selected date range (decision block 210 is No), a calendar or scheduling page is generated (block 212), and the process concludes (block 216). However, in the event there are federated calendar events in the selected date range (decision block 210 is Yes), a calendar and/or scheduling page is generated with indicators for federated calendars with events in the selected date range (block 214), and the process concludes (block 216).

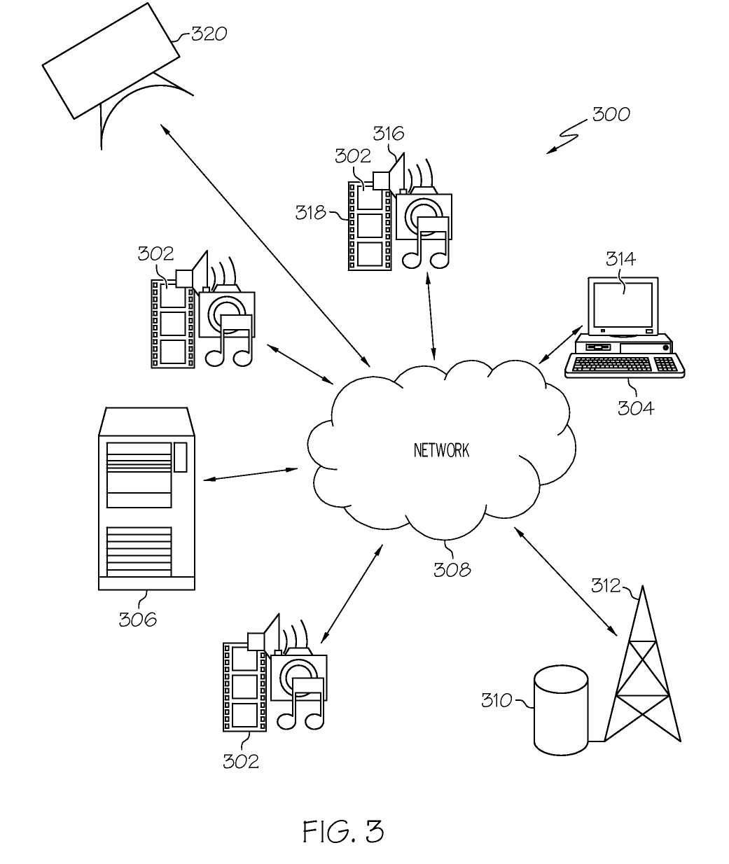

FIG. 3 illustrates an exemplary system 300 for an electronic calendar and/or scheduling application that indicates the presence of federated calendar entries in a currently viewed time period of the calendar and/or scheduling application according to embodiments of the invention. The system 300 includes multimedia devices 302, and desktop computer devices 304 configured with display capabilities 314. The multimedia devices 302 may be mobile communication and entertainment devices, such as cellular phones and mobile computing devices that are wirelessly connected to a network 308. The multimedia devices 302 have video displays 318 and audio outputs 316. The multimedia devices 302 and desktop computer devices 304 may be configured with calendar and/or scheduling software with a GUI for implementing embodiments of the invention. The network 308 may be any type of known network including a fixed wire line network, cable and fiber optics, over the air broadcasts, satellite 320, local area network (LAN), wide area network (WAN), global network (e.g., Internet), intranet, etc. with data/Internet capabilities as represented by server 306. Communication aspects of the network are represented by cellular base station 310 and antenna 312.

The federated calendars and the calendar and/or scheduling software may be resident on the individual multimedia devices 302 and desktop computers 304, or stored within the server 306 or cellular base station 3 10.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for indicating the presence of federated calendar entries in a currently viewed time period of a calendar and/or scheduling application, the method comprising:
receiving a user's selection for a date range in a calendar and/or scheduling application;
determining whether there are one or more federated calendars associated with the user's calendar and/or scheduling application;
wherein in the event there are one or more federated calendars associated with the user's calendar and/or scheduling application:
determining whether there are one or more events from the one or more federated calendars in the selected date range; and
wherein in the event there are one or more events in the selected date range:
generating a calendar and/or scheduling page with one or more indicators for the federated calendars with the one or more events in the selected date range.

2. The method of claim 1, wherein the one or more indictors are highlighted or in bold, in the event the one or more events are currently visible on the generated calendar and/or scheduling page.

3. The method of claim 1, wherein the one or more indictors are faint or transparent, in the event the one or more events fall in the selected date range, but are currently not visible on the generated calendar and/or scheduling page.

4. The method of claim 1, wherein the one or more indicators appear in the event that one or more events are present in the calendar but are not currently visible on the generated calendar and/or scheduling page.

5. The method of claim 1, wherein one or more indicators appear in the event that the federated calendar does not contain any entries at all.

6. The method of claim 1, wherein hovering over the one or more indicators results in a pop up with additional information for a federated calendar entry.

7. The method of claim 1, wherein the calendar and/or scheduling page with the one or more indicators is generated with a graphical user interface.
